(19) United States
(12) Patent Application Publication
(10) Pub. No.: US 2025/0339946 A1
(43) Pub. Date: Nov. 6, 2025

(54) INTELLIGENT ELECTRIC DRILL WITH SPEED AND FUNCTION MODE RECOGNITION

(71) Applicant: DARREN WANG, Irvine, CA (US)

(72) Inventor: DARREN WANG, Irvine, CA (US)

(21) Appl. No.: 18/653,954

(22) Filed: May 2, 2024

(51) Int. Cl. B25F 5/00; B23B 45/02; B25F 5/02

(52) U.S. Cl. CPC B25F 5/001; B23B 45/02; B23B 2270/32; B23B 2270/483; B23B 2270/486; B25F 5/02

(57) ABSTRACT

An intelligent electric drill includes a case which has an MCU control unit, a drive unit, a power unit, and a data unit. The MCU control unit controls the power, speed, and torque of the drive unit. A mechanical speed mode recognition module group is electrically connected to the MCU control unit and includes a speed mode recognition electronic module and a plastic speed mode module within the case. The mechanical speed mode recognition module group determines the switching position of the plastic speed mode module, and the speed mode recognition electronic module inputs the determined signal to the MCU control unit. This allows users to automatically recognize the positions of mechanical speed mode and function mode while driving with the electric drill. Users can drive with accurate and appropriate power, achieving precise output of speed, torque, and workload.

### FIELD OF THE INVENTION

The present invention relates to a field of electric tools, and more particularly, to an intelligent drill electric tool with speed and function mode recognition.

### BACKGROUND OF THE INVENTION

Most of the electric tools on the market only have a single speed for driving, and it's rare to find ones with adjustable driving speeds and torque. Users often can't gauge or understand how much force the electric tool is exerting during operation. Some electric tools rely on the amount of battery power available, the more power, the greater the driving force, and vice versa. It's common to encounter situations where electric tools stop working halfway through. However, some of the latest models come with multifunctional adjustments, usually located at the bottom of the tool. These adjustments can only be made when the tool is not in use, following the instructions in the manual or indicated by indicator lights. This inconvenience for users is compounded by the limited adjustment options available, making it impossible to accurately and reasonably control the power output for the current task at hand. Therefore, it's imperative for relevant manufacturers to improve the judgment of driving speed, torque, and other related aspects of electric tools to overcome these issues.

The present invention intends to provide an intelligent electric drill with speed and function mode recognition to eliminate the shortcomings mentioned above.

### SUMMARY OF THE INVENTION

The present invention relates to an intelligent electric drill and comprises a case which has an MCU control unit, a drive unit, a power unit and a data unit. The drive unit and the power unit are electrically connected to the MCU control unit. The MCU control unit controls power, speed, and torque of the drive unit. The power unit provides power to the MCU control unit. A mechanical speed mode recognition module group is electrically connected to the MCU control unit, and comprises a speed mode recognition electronic module and a plastic speed mode module installed within the case. The mechanical speed mode recognition module group determines a switching position of the plastic speed mode module, and the speed mode recognition electronic module then inputs a determined signal to the MCU control unit. A user manually adjusts a speed mode or a function mode of the case for different workplaces, then activates the electric drill such that the electric drill automatically switches and adjusts corresponding speed and torque.

The primary object of the present invention is to provide an intelligent electric drill which provide users with automatic recognition of the positions of mechanical speed mode and function mode while driving with the electric tool. With this assistance, users can drive with accurate and appropriate power, achieving precise output of speed, torque, workload, etc. This addresses the shortcomings of conventional electric tools, which cannot provide targeted driving force for the objects to be driven.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a block diagram of the intelligent electric drill of the present invention;

FIG. 2 is a perspective view of the intelligent electric drill of the present invention;

FIG. 3 is a schematic diagram illustrating the action of adjusting the rotating ring of the intelligent electric drill of the present invention, and

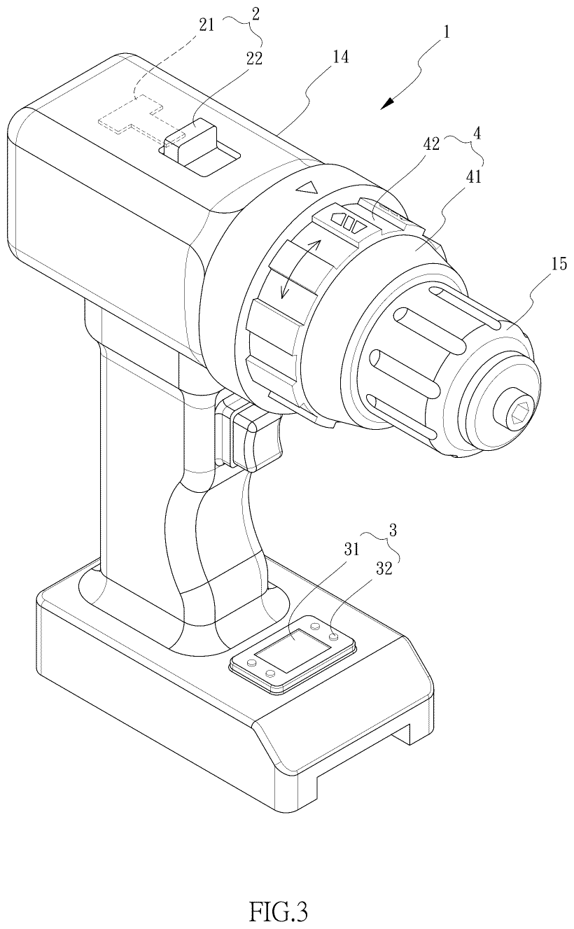

FIG. 4 is an exploded view showing the rotating ring and the positioning ring of the intelligent electric drill of the present invention.

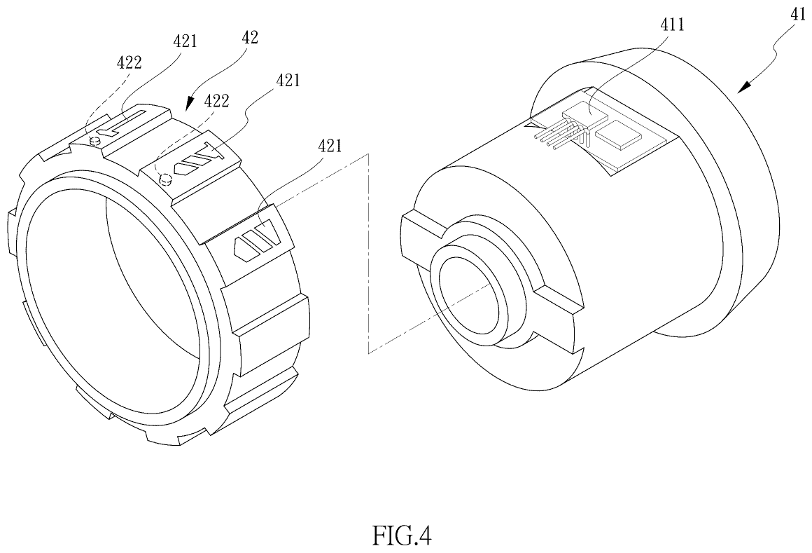

### DETAILED DESCRIPTION OF THE PREFERRED EMBODIMENT

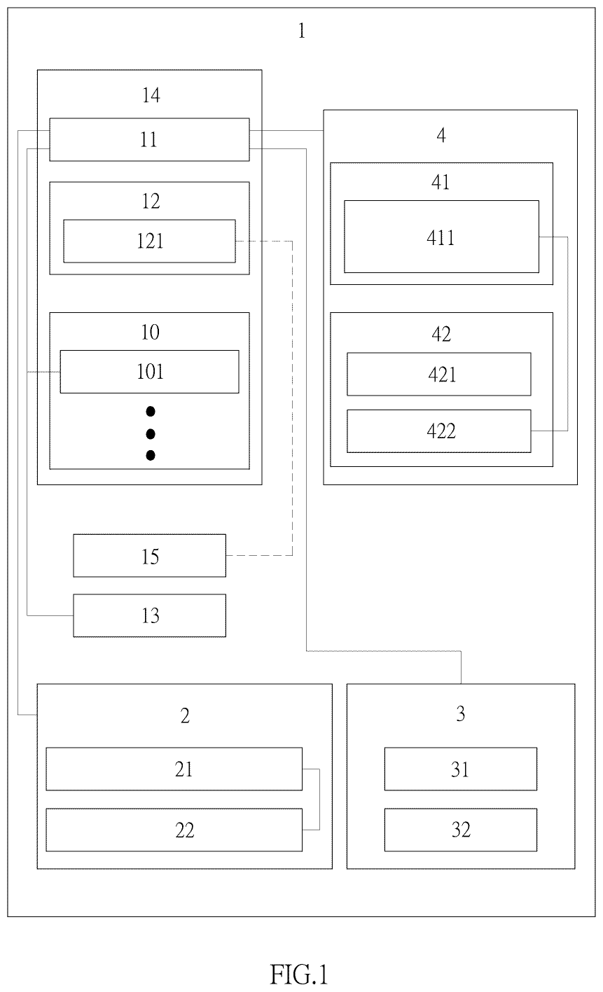

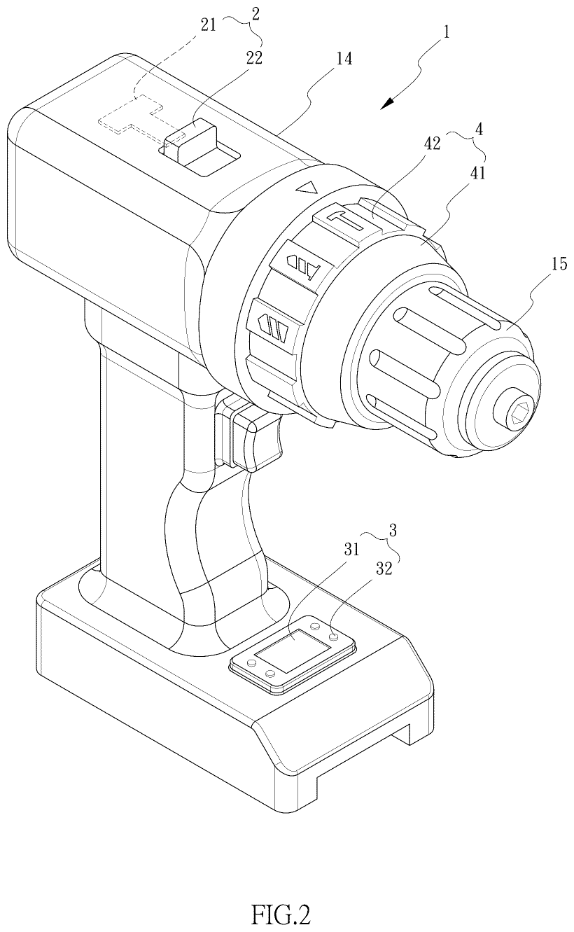

Referring to FIGS. 1 and 2, the intelligent pistol drill electric tool with speed and function mode recognition comprises a case 1 primarily used to drive accessories (such as screwdriver heads, sockets, etc., for drilling, screwing, etc.), internally equipped with an MCU control unit 11, a drive unit 12, a power unit 13, and a data unit 10. The MCU control unit 11 serves as the main central control of the case 1, while the drive unit 12 is the main driving operation core within the case 1. The power unit 13 is the main power source, and the drive unit 12 and the power unit 13 are electrically connected to the MCU control unit 11. The MCU control unit 11 controls the power, speed, and torque of the drive unit 12. The power unit 13 supplies power to the MCU control unit 11 for driving. Additionally, there is a mechanical speed mode recognition module group 2, primarily used to provide the case 1 with appropriate adjustments for the accessories to be driven. The mechanical speed mode recognition module group 2 includes a built-in speed mode recognition electronic module 21 and a plastic speed mode module 22 within the case 1. The speed mode recognition electronic module 21 is electrically connected to the MCU control unit 11 and the plastic speed mode module 22. The speed mode recognition electronic module 21 determines the switching of the plastic speed mode module 22, and then inputs the determined electrical signal to the MCU control unit 11. This allows the MCU control unit 11 to adjust the operation of the drive unit 12 based on the relevant information transmitted by the speed mode recognition electronic module 21 to the corresponding data unit 10. Through the mechanical speed mode recognition module group 2, users can switch and adjust power, speed, and torque accordingly for different workplaces and environments so as to operate the electric drill with the most suitable driving force.

When the user operates the case 1 for driving, the user can first determine the operation to be performed, and then adjust the case 1 by the plastic speed mode module 22. After the adjustment and switching are completed, the speed mode recognition electronic module 21 receives the aforementioned adjustment, sends the electrical signal to the MCU control unit 11, and upon receiving the signal, the MCU control unit 11 adjusts the drive unit 12 and the power unit 13 according to the information in the corresponding data unit 10 to match the data parameters. Once the adjustment is confirmed, the user can quickly drive the accessories they want to drive, ensuring that the output driving force and the power supply capacity are matched to the accessories to be driven, operating at the most suitable speed, torque, and workload, thereby avoiding unnecessary consumption and protecting all internal components of the case 1. Unlike conventional technology, which only has a single gear and speed and cannot accurately drive different accessories, causing unnecessary consumption of power and driving force.

In order to allow users to accurately switch and adjust, the data unit 10 is built with multiple mode data files 101. The data information in each mode data file 101 is different, and each mode data file 101 contains parameters such as speed, torque, and output power. In simple terms, users can first determine the accessories they want to drive or the driving mode they want to perform, then adjust and switch the plastic speed mode module 22 to select any mode data file 101. This allows users to drive the accessories with the most suitable driving force, avoiding unnecessary power and driving force consumption. Additionally, to drive the accessories with the most accurate driving force, the present invention further includes an LCD and keypad combination module 3 on the outer periphery of the case 1. The LCD and keypad combination module 3 is electrically connected to the MCU control unit 11 and includes an LCD screen 31 and multiple keys 32. Each key 32 is pressed to adjust and set the information transmitted from the speed mode recognition electronic module 21 to the MCU control unit 11. The LCD screen 31 displays the information transmitted from the speed mode recognition electronic module 21 to the MCU control unit 11, as well as the adjusted information values of each key 32. Therefore, when users do not know how to switch the plastic speed mode module 22, they can first test the accessories to be driven. Then, the drive unit 12 will send the measured speed, torque, and other relevant information to the MCU control unit 11, which will display the relevant data on the LCD screen 31. Users can directly observe and understand the current need to switch and adjust the gear status to match the driving operation. Not only that, the invention can also display the final data obtained during the selection of the gear and completion of the driving process on the LCD screen 31, providing users with information on whether the final driving status is accurate.

In order to be used in different usage environments (such as drill mode, drilling mode, etc., different construction modes require different gear positions), the present invention provides users with more precise and accurate adjustments. The case 1 is further divided into a body portion 14 and a drive transmission portion 15. The drive conversion part 15 is installed at one end of the electric body portion 14, while the power unit 13 is installed at the bottom of the body portion 14. Additionally, a function mode adjustment recognition module 4 is provided between the body portion 14 and the drive transmission portion 15. The function mode adjustment recognition module 4 includes a rotating ring 42 and a positioning ring 41. The positioning ring 41 is assembled on one driving rod 121 of the drive unit 12, mainly used to fix the assembly of a function mode electronic recognition module 411 and the drive unit 12. The rotating ring 42 is provided with multiple mode images 421 on its outer surface and a magnet 422. Each mode image 421 corresponds to a mode data file 101. Therefore, when the rotation of the rotating ring 42 is sensed by the function mode electronic adjustment recognition module 411, and the function mode electronic adjustment recognition module 411 is electrically connected to the MCU control unit 11, the function mode electronic adjustment recognition module 411 can send corresponding electrical signals to the MCU control unit 11. This allows the MCU control unit 11 to adjust the drive unit 12 and power unit 13 to the current needs and conditions, in coordination with the adjustment of the mechanical speed mode recognition module group 2, thus allowing for the required control.

The present invention utilizes the control of the mechanical speed mode recognition module group 2 and the switching of the function mode adjustment recognition module 4 to adjust and switch according to the accessories to be driven, the working environment, etc. By adjusting and switching the plastic speed mode module 22, it can precisely control the accessories under the most accurate conditions such as speed and torque, and with the setting of the LCD and keypad combination module 3. Users can make fine adjustments, enabling them to use it in a more suitable and accurate mode, thereby reducing power and drive consumption, and ensuring the longevity of the internal components of the case 1.

While we have shown and described the embodiment in accordance with the present invention, it should be clear to those skilled in the art that further embodiments may be made without departing from the scope of the present invention.

What is claimed is:

1. An intelligent electric drill comprising:
a case (1) which has an MCU control unit (11), a drive unit (12), a power unit (13) and a data unit (10), the drive unit (12) and the power unit (13) electrically connected to the MCU control unit (11), the MCU control unit (11) controlling power, speed, and torque of the drive unit (12), the power unit (13) providing power to the MCU control unit (11);
a mechanical speed mode recognition module group (2) electrically connected to the MCU control unit (11), and comprising a speed mode recognition electronic module (21) and a plastic speed mode module (22) installed within the case (1), the mechanical speed mode recognition module group (2) determining a switching position of the plastic speed mode module (22), the speed mode recognition electronic module (21) then inputting a determined signal to the MCU control unit (11), wherein a user manually adjusts a speed mode or a function mode of the case (1) for different workplaces, then activates the electric drill, the electric drill automatically switches and adjusts corresponding speed and torque.

2. The intelligent electric drill as claimed in claim 1, wherein the data unit (10) includes multiple mode data files (101), each mode data file (101) contains different data information, each mode data file (101) includes multiple parameters, any mode data file (101) is selected when adjustment and switching of the speed mode recognition electronic module (21) and the plastic speed mode module (22) are made.

3. The intelligent electric drill as claimed in claim 2, wherein the case (1) comprises a body portion (14) and a drive transmission portion (15), the drive transmission portion (15) is installed at one end of the body portion (14), the power unit (13) is installed at a bottom of the body portion (14), a function mode adjustment recognition module (4) is connected between the body portion (14) and the drive transmission portion (15), the function mode adjustment recognition module includes a rotating ring (42) and a positioning ring (41), the positioning ring (41) is mounted on a driving rod (121) of the drive unit (12) and secures a function mode electronic recognition module (411) and the drive unit (12), the function mode electronic recognition module (411) is electrically connected to the MCU control unit (11), the rotating ring (42) includes multiple mode images (421) and a magnet (422) connected to an outer surface thereof, each mode image (421) corresponds to a mode data file (101).

4. The intelligent electric drill as claimed in claim 1, wherein the case (1) includes an LCD and keypad combination module (3) located on an outer periphery thereof, the LCD and keypad combination module (3) is electrically connected to the MCU control unit (11) and comprises a liquid crystal display screen (31) and multiple keys (32), an information is adjusted and set, and is transmitted from the mechanical speed mode recognition module group (2) to the MCU control unit (11) when pressing each key (32), the liquid crystal display screen (31) displays the information transmitted from the mechanical speed mode recognition module group (2) to the MCU control unit (11), as well as an adjusted information of each key (32).
